(19) United States
(12) Patent Application Publication
(10) Pub. No.: US 2005/0036575 A1
(43) Pub. Date: Feb. 17, 2005

(54) Method and apparatus providing low complexity equalization and interference suppression for SAIC GSM/EDGE receiver

(75) Inventors: Kiran Kumar Kuchi, Irving, TX (US); Gian Paolo Mattellini, Helsinki (FI); JOHN DERYK WATERS, (US); JAMES THOMAS EDWARD MCDONNELL, (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/641,733

(22) Filed: Aug. 15, 2003

(51) Int. Cl. H04L 25/08

(52) U.S. Cl. 375/348

(57) ABSTRACT

Disclosed is a RF receiver that includes baseband circuitry for performing Minimum Mean-Square Error (MMSE) optimization for substantially simultaneously suppressing inter-symbol interference (ISI) and co-channel interference (CCI) on a signal stream that comprises real and imaginary signal components. In a preferred embodiment the receiver includes a single receive antenna, and operates as a single/multi antenna interference cancellation (SAIC) receiver. The baseband circuitry operates to determine a set of In-Phase and Quadrature Phase (I-Q) MMSE vector weights that are used to perform the ISI suppression and the CCI suppression. A method for operating the receiver is also disclosed.

### TECHNICAL FIELD

This invention is related to single/multi antenna interference cancellation (SAIC) in wireless communications systems, such as GSM systems, using a single receiver antenna.

### BACKGROUND OF THE INVENTION

Network operators typically experience locations where interference levels are high and where bandwidth usage for some base stations approaches the saturation level. Although the majority of traffic currently consists of conventional voice calls, the acceptance of data services via GPRS and EDGE is expected to increase the interference and bandwidth usage problems.

In order to maximize the voice capacity of their networks, GSM operators must use their radio frequency (RF) spectrum as efficiently as possible. To achieve this, the GSM standard combines frequency-division multiple access with time-division multiple access (TDMA) techniques to provide ifive communication channels per MHz bandwidth and eight time slots.

Operators would ideally like to achieve 1:1 cellular-frequency reuse. In this scheme, which is being deployed in North America, every cell in the network can transmit on every available frequency channel. However, this is difficult to achieve in practice because the signals from a base station propagate well past the cell boundary, resulting in co-channel interference. This occurs when a handset in one cell receives a signal from an adjacent cell that is broadcast on the same channel and in the same TDMA timeslot, but is destined for another handset. If the strength of this interfering signal is not well below the strength of the local signal, the handset will experience degraded audio quality or may even drop the call.

Co-channel interference can affect a significant portion of a GSM network because the irregular positioning of cells and the impact of local geography on radio-wave propagation often cause critical levels of interference. This can occur even if frequencies are only reused in cells that are separated by two or more other cells. As a result, co-channel interference affects most wireless networks and presents a challenge to network operators, who wish to increase frequency reuse in order to maximize network capacity.

Co-channel interference can be mitigated using a number of different techniques. These include frequency hopping, which reduces the period of time during which co-channel interference is experienced on any single channel. This allows problems related to interference to be overcome by error-correction schemes. Other schemes include layered systems, in which 1:1 channel reuse is restricted to areas close to the base station, and dynamic power control, which maintains the base-station and handset transmit power levels at a minimum acceptable level. Also available are discontinuous transmission techniques, which interrupt the transmission during periods when users are not actually talking.

More recent techniques include the use of an adaptive-multirate voice codec, which allows a channel's 22.8 kbit/s gross data-transmission rate to be dynamically divided between the net voice data rate and the error-correction data rate. This technique can preserve call viability under poor signal conditions by performing a dynamic allocation of radio channels in response to a continuous analysis of interference conditions in each cell.

The foregoing techniques are typically not used on an individual basis, but are used instead in various combinations to achieve typical voice capacities that are still less than the theoretical 1:1 reuse maximum. In general, these techniques cannot be used to extend voice capacity close to the maximum figure, as they attempt to eliminate or average-out co-channel interference rather than coping with it.

Other attempts have been made to address co-channel interference by improving the receiver performance of handsets through the use of antenna diversity. This technique uses more than one antenna to exploit the fact that signal conditions can vary in terms of position and the polarization of the electromagnetic wave. However, the use of antenna diversity within a handset requires a more complicated antenna implementation and additional RF components, thus increasing handset cost, complexity and power consumption.

In response to these problems, the single-antenna interference cancellation (SAIC) technique has been developed, and offers a considerable improvement in system performance without unduly increasing handset size, cost or power consumption. SAIC uses a single antenna and RF circuit, while significantly improving the handset's immunity to co-channel interference. This is accomplished through the use of algorithms executed by the handset's digital signal processor (DSP). In addition to canceling co-channel interference, SAIC also addresses adjacent-channel interference, which is caused by the unintentional spectral overlap of neighboring frequency channels.

However, the use of the SAIC technique introduces a further problem, i.e., the proper design of a high performance SAIC receiver that has an affordable complexity. Conventional GSM receivers were optimized to yield near optimal link performance offered by a trellis sequence estimator. With the introduction of SAIC algorithms, there is a renewed interest in developing a low complexity, high performance GSM receiver algorithm. The goal is to provide a wide range of algorithmic choices at different levels of computational complexity and performance, as it is expected that low complexity baseband algorithms will enable the introduction of low cost GSM handsets. Further, the available computational power (i.e., DSP MIPS) may be better allocated between low complexity baseband algorithms and other desirable functions, such as providing computationally intensive features such as video games and musical capabilities. In addition, the use of high performance, high complexity baseband algorithms can be used, when necessary, to improve coverage/data rates/capacity with the availability of sufficient computational power.

A number of SAIC approaches have been proposed in the literature. Examples include: Ottersen, Kristensson, Astely, “A receiver”, International Publication Number WO 01/93439; Arslan, Khayrallah, “Method and Apparatus for Canceling Co-Channel Interference in a Receiving System Using Spatio-Temporal Whitening” International Publication Number WO 03/030478 A1; Meyer, Schober, Gerstacker, “Method for Interference Suppression for TDMA-and/or FDMA Transmission”, filed Dec. 19, 2001. Also of interest are B. Picinbono and P. Chevalier, “Widely Linear Estimation with Complex Data,” IEEE Trans. On. Signal Proc, vol. 43, pp. 2030-2033, August, 1995; W. H. Gerstacker et al, “Equalization with Widely Linear Filtering,” ISIT2001; G. Gelli et al, “Blind Widely Linear Multiuser Detection”, IEEE Comm Letters, June 2000; W. A. Gardner, S. V. Schell, “GMSK Signal Processors For Improved Communications Capacity and Quality, U.S. Pat. No. 5,848,105, Dec. 8, 1998; and W. H. Gerstacker et al, “A Blind Widely Linear Minimum Output Energy Algorithm”, WCNC 2003.

The receiver disclosed in WO 01/93439 exploits the fact that if (co-channel) interference is considered to be colored noise, and the noise is whitened, signal gain can be achieved. WO 01/93439 discloses the use of a filter that is said to provide efficient whitening by exploiting the additional degree of freedom that arises from the separation of the real and imaginary components of the received signal, i.e., of the in-phase and quadrature-phase (I-Q) components. The teachings of WO 03/030478 A1 are similar to WO 01/93439 in respect to suppressing co-channel interference.

In WO 01/93439 the interference is modeled as an IIR (infinite impulse response) process with order K, and the whitening operation is performed by a (multidimensional) FIR (finite impulse response) filter with K (or K+1) filter taps. After the whitening operation, the impulse response of the wanted signal is of course modified; in particular, because of the convolution with the whitening filter, the whitening operation of WO 01/93439 exhibits what may be referred to as an increased channel length, i.e., the impulse response of the wanted signal becomes longer, requiring a more complex equalizer, or at least a modified equalizer that includes some mechanism to take into account the increased channel length. The increased channel length requires that the equalizer of a receiver be modified if the whitening operation per WO 01/93439 is to be implemented by the receiver.

Additionally the achievable performance gain obtainable using the whitening operation of WO 01/93439 depends on the model parameter K indicating the number of taps of the FIR filter. In general, the greater is the value of K the greater is the gain, but if K exceeds a certain threshold (which depends on the particular interference being suppressed and so is in principle not a priori known) the problem of finding the FIR filter coefficients can become ill-conditioned, i.e., the FIR filter cannot be found.

What is therefore needed is a more robust, less complex method of suppressing co-channel interference based on noise whitening, one that is more readily integrated into existing receivers, such as GSM (Global System for Mobile Communications)/EDGE (Enhanced Data Rates for GSM Evolution) receivers.

In commonly assigned U.S. patent application Ser. No. 10/______, filed ______, “Method and Apparatus for Suppressing Co-Channel Interference in a Receiver”, Mattellini, Kuchi and Ranta address the foregoing needs, and describe a simple and efficient I-Q whitening method that is based on a so-called “truncated I-Q whitening” solution. In this approach the whitening operation is performed within one symbol.

While the receiver structure disclosed in the above-referenced commonly assigned U.S. patent application is well-suited for its intended application, receiver structures capable of providing even higher performance and even lower complexity are desired.

### SUMMARY OF THE PREFERRED EMBODIMENTS

The foregoing and other problems are overcome, and other advantages are realized, in accordance with the presently preferred embodiments of these teachings.

This invention provides improved performance through the use of full I-Q received signal temporal whitening, while at the same time enabling a number of lower complexity receiver designs to be realized, for instance the I-Q MMSE linear equalizer. This invention also improves adjacent channel interference rejection capability when used with either a narrowband or wide band receiver filter. This invention also provides interference suppression without requiring over-sampling of the received signal.

In accordance with an aspect of this invention, and different from the approaches of the prior art, the filters are not calculated as the inverse of an IIR filter, and the whitening operation is extended over more than one received symbol.

Disclosed is a RF receiver that includes baseband circuitry for performing Minimum Mean-Square Error (MMSE) optimization for substantially simultaneously suppressing inter-symbol interference (ISI) and co-channel interference (CCI) on a signal stream that comprises real and imaginary signal components. In another embodiment an RF receiver that includes baseband circuitry for performing Minimum Mean-Square Error (MMSE) optimization for suppressing co-channel interference (CCI) and mitigation of inter-symbol interference (ISI) by subsequent equalization or detection is disclosed. In a preferred embodiment the receiver includes a single receive antenna, and operates as a single antenna interference cancellation (SAIC) receiver. In an alternative embodiment the receiver includes multiple receive antennas and operates as a multi antenna interference canceller. The baseband circuitry operates to determine a set of In-Phase and Quadrature Phase (I-Q) MMSE vector weights that are used to perform the ISI suppression and the CCI suppression. A method for operating the receiver is also disclosed.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram of a first embodiment of a I-Q MMSE receiver that includes an I-Q multi-channel matched filter and a I-Q MMSE filter;

FIG. 2A is a simplified block diagram of a second embodiment of a I-Q MMSE receiver that includes an I-Q whitened matched filter and a scalar MMSE equalizer designed for white noise;

FIG. 2B is a simplified block diagram of the second embodiment of a I-Q MMSE receiver that includes an I-Q whitened matched filter and a MAP sequence estimator with matched filter metric (Ungerboeck);

FIG. 2C is a simplified block diagram of a further embodiment of a I-Q MMSE receiver that includes an I-Q whitened matched filter, an anticusal filter which produces a minimum phase channel, and a detector which could be a MAP sequence estimator with Euclidean filter metric (Forney), a Reduced State Sequence Estimator (RSSE) or a Decision Feedback Estimator (DFE);

FIG. 3A is a simplified block diagram of a third embodiment of a MMSE receiver that includes an I-Q pre-whitener and a MMSE equalizer optimized for white noise;

FIG. 3B is a simplified block diagram of the third embodiment of a MMSE receiver that includes an I-Q pre-whitener and a MAP sequence estimator; and

FIG. 4 is a simplified block diagram of an IQ-MMSE receiver embodiment that includes a whitening I-Q MMSE-DFE pre-filter that outputs a signal suitable for a detector such as a MAP sequence estimator with Euclidean filter metric (Forney), a Reduced State Sequence Estimator (RSSE), or a Decision Feedback Estimator (DFE).

### DETAILED DESCRIPTION OF THE PREFERRED EMBODIMENTS

By way of introduction, it is noted that conventional received signal equalizers typically operate with baseband complex signals. An aspect of this invention is a method that performs both equalization and interference suppression directly on the real and imaginary parts of a received signal real constellation. By doing so, the equalizer causes a reduced amount of noise enhancement or lower mean square error between the desired sequence and the filtered sequence, and provides improved interference suppression, as compared to other techniques known to the inventors.

The invention is directed in general to a SAIC receiver that employs Minimum Mean-Square Error (MMSE) optimization for realizing joint Inter-symbol Interference (ISI) and interference suppression on real and imaginary signal streams. The invention employs novel I-Q MMSE and I-Q MMSE-DFE (Decision Feedback Equalizer) design criterion.

The use of this invention provides a set of I-Q MMSE vector weights that perform ISI suppression and Co-Channel Interference (CCI) suppression in one step. The signal and interference correlation matrices are utilized when calculating I-Q MMSE coefficients. The weights may be synthesized using FIR or frequency domain (such as FFT) calculations. After multiplying the I-Q MMSE vector with the received vector the receiver can make bit soft decisions on the desired signal, such as by using a reduced state sequence estimator that makes soft bit decisions on the I-Q filtered output.

The use of this invention also provides an I-Q pre-whitener or whitened matched filter (WMF) matrix that is synthesized based on the I-Q interference correlation matrix. The I-Q pre-whitener/WMF matrix coefficients are preferably computed in the FIR or frequency domain using FFT techniques. The I-Q pre-whitened/WMF signal streams are preferably further processed by a sequence estimator operating with combined I-Q branches within the branch metric, using either Euclidian or Ungerboeck metrics.

In a first embodiment, an I-Q MMSE embodiment, both the desired and co-channel users are assumed to be restricted to using a real modulation alphabet (i.e. one dimensional modulation alphabet), in order to allow convenient I-Q processing. The signal model accommodates: (a) over-sampling by a factor of l (multiple receive antennas can be treated as additional over-samples), (b) an arbitrary number of co-channel or adjacent channel interferers (M−1), and (c) additional thermal noise.

Further, the description that follows assumes a single antenna receiver, this being an especially advantageous application of the invention; however the invention can easily be extended to accommodate more than one receiver antenna, and the samples received from a plurality of antennas can be treated equivalently as fractional samples. Further still, although the invention is described in respect to binary PAM (Pulse Amplitude Modulation), so that the symbols x are restricted to the interval (−1,1), the invention is not limited to binary PAM as the invention has potential application in systems in which any kind of binary modulation or multi level PAM is employed, including e.g. BPSK (binary phase shift keying), and MSK (minimum shift keying). The invention is also applicable for offset-QAM modulations such as binary offset QAM and quaternary-offset QAM as they can be viewed as binary or quaternary PAM signals by applying a proper rotation every symbol. In particular, the invention is suitable for GMSK (Gaussian minimum shift keying) modulation utilized, e.g. in GSM and Bluetooth, as it is known in the art that GMSK can be closely approximated by binary modulation.

In FIG. 1, the RF front end 12 represents many different functionalities that are necessary for receiver operation, including functionalities separable from those provided for by the invention, such as e.g. means for channel estimation, means for frequency offset estimation, means for DC offset compensation, means for signal de-rotation (signal de-rotation by a factor i^{-k}, where i=\sqrt{−1} is applied in case of GMSK modulation). Basically, as indicated in FIG. 1, the RF front end 12 gives as output baseband samples y(k) of the received signal represented as,

$${y}_{k , q} = {\sum }_{p = 0}^{v} {x}_{k - p}^{( 1 )} {h}_{p , q}^{( 1 )} + {\sum }_{j = 2}^{M} {\sum }_{p = 0}^{v} {x}_{k - p}^{( j )} {h}_{l , q}^{( j )} + {n}_{k , q} , q = 1 , 2 … l$$

In this embodiment it is preferred to first stack the real and imaginary parts of the time domain received signal in a column vector, then the received signal in the frequency-domain can be represented as

$$y ( f ) = {h}_{1} ( f ) {x}_{1} ( f ) + {\sum }_{j = 2}^{M} {h}_{j} ( f ) {x}_{j} ( f ) + n ( f ) , \\ where , \\ {h}_{j} ( f ) = {[ {g}_{I , 1}^{( j )} ( f ) … {g}_{I , q}^{( j )} ( f ) … {g}_{I , l}^{( j )} ( f ) {g}_{Q , 1}^{( j )} ( f ) … {g}_{Q , q}^{( j )} ( f ) … {g}_{Q , l}^{( j )} ( f ) ]}^{T} .$$

The notation T denotes the matrix transpose operation and g is defined as the Discrete Fourier Transform (DFT) of the real and imaginary parts of the channel impulse response as follows

$$\begin{matrix}{g}_{I , q}^{( j )} ( f ) = {\sum }_{p}^{} Re \{ {h}_{p , q}^{( j )} \} {ⅇ}^{j 2 π pfT} \\ {g}_{Q , q}^{( j )} ( f ) = {\sum }_{p}^{} I m \{ {h}_{p , q}^{( j )} \} {ⅇ}^{j 2 π pfT}\end{matrix}$$

and h_{p,q}^{(j)} is the impulse response of the pth channel tap of jth user, and p runs from 0 to v with 0≦p≦v and v equal to one less than the channel impulse response length.

The I-Q split receiver signal is represented as

$$y ( f ) = {[ {y}_{I , 1} ( f ) … {y}_{I , q} ( f ) … {y}_{I , l} ( f ) {y}_{Q , l} ( f ) … {y}_{Q , q} ( f ) … {y}_{Q , l} ( f ) ]}^{T} , \\ where$$

$${y}_{I , q} ( f ) = {\sum }_{k}^{} Re \{ {y}_{k , q} \} {ⅇ}^{j 2 π kfT}$$

$${y}_{Q , q} ( f ) = {\sum }_{k}^{} Im \{ {y}_{k , q} \} {ⅇ}^{j 2 π kfT} .$$

The DFT of the real desired symbol sequence is defined as

$${x}_{j} ( f ) = {\sum }_{k}^{} {x}_{k}^{( j )} {ⅇ}^{j 2 π k fT}$$

and the I-Q split noise is defined as

$$n ( f ) = {[ {n}_{I , 1} ( f ) … {n}_{I , q} ( f ) … {n}_{I , I} ( f ) {n}_{Q , 1} ( f ) … {n}_{Q , q} ( f ) … {n}_{Q . l} ( f ) ]}^{T} , \\ {n}_{I , q} ( f ) = {\sum }_{k}^{} Re \{ {n}_{k , q} \} {ⅇ}^{j 2 π kfT}$$

$${n}_{Q , q} ( f ) = {\sum }_{k}^{} Im \{ {n}_{k , q} \} {ⅇ}^{j 2 π kfT}$$

One then finds an MMSE filter w(f) that minimizes the mean square error term defined as
MSE=o∫E└∥w(f)y(f)−x₁(f)∥²┘df
Direct Form of I-Q MMSE

Following, for example, Sirikiat Lek Ariyavisitakul, J. H. Winters, “Optimum Space-Time Processors with Dispersive Interference: Unified Analysis and Required Filter Span”, IEEE Trans on Comm, July 1999, and J. Cioffi “Class Notes EE 379A Stanford University” http://www.stanford.edu/class/ee379a/, the MMSE weights in direct form are given by:

$$w ( f ) = \underbrace{{h}_{1}^{*} ( f ) }_{I - QMF} \underbrace{{[ {R}_{SS} ( f ) + {R}_{ii} ( f ) ]}^{- 1}}_{I - Q MMSE For Colored Noise}$$

where R_{SS}(f)=h₁(f)h₁*(f) is the desired auto-correlation for the desired signal and Rᵢᵢ(f)=E[i(f)i*(f)] is the interference plus noise auto-correlation. The notation * indicates a conjugate transpose operation. Note that

$$i ( f ) = {\sum }_{j = 2}^{M} {h}_{j} ( f ) {x}_{j} ( f ) + n ( f ) and {R}_{ii} ( f ) = {\sum }_{j = 2}^{M} {h}_{j} ( f ) {h}_{j}^{*} ( f ) + \frac{{N}_{0}}{2} I$$

where I is an identity matrix of the appropriate dimensions.

Referring again to FIG. 1, the MMSE receiver 10 includes an RF front-end 12 connected to an antenna 12A, an I-Q multi-channel matched filter 14 that is matched to the desired signal, and a I-Q equalizer 16 that takes into account interference plus noise statistics across both the I-Q and temporal dimensions.

Based on the foregoing, it is shown that an efficient GSM receiver can be designed in accordance with a number of different design alternatives. For example, the GSM receiver can be designed as an inexpensive IQ-MMSE linear equalizer receiver 16. In this embodiment the channel output is applied to a channel estimation block, which outputs I and Q samples to the IQ-MMSE linear equalizer 16 that in turn outputs soft bit estimates.

Frequency Domain Implementation

The frequency domain formulation allows one to derive an algorithm convenient for practical implementation. First, it is preferred to constrain the equalizer weight vector w(f) to be of finite length, and to then make use of a computationally efficient Fast Fourier Transform (FFT) algorithm to calculate the equalizer settings. By the nature of FFT, the equalizer settings are constrained to be finite both in time and frequency. The FFT length is a design parameter, which can be selected as a compromise between performance and complexity. The FFT solution approaches the exact MMSE solution in the limiting case when the FFT length approaches infinity. The preferred FFT algorithm may be outlined as follows:
(A) take a N_{f} point FFT to construct h₁(fₙ) of size 2l×1; where the discrete frequency variable fₙ assumes the N_{f} values −1/2+1/(N_{f}*T) . . . , −2/(N_{f}*T), −1/(N_{f}*T), 0, 1/(N_{f}*T), 2/(N_{f}*T) . . . , 1/2−1(N_{f}*T);
(B) construct Rᵢᵢ(fₙ) by taking the FFT of each time domain interference autocorrelation stream;
(C) invert [h₁(fₙ)h₁*(fₙ)+Rᵢᵢ(fₙ)] of size 2l×2l for each frequency bin; and
(D) calculate w(fₙ) of size 1×2l, and take the IFFT of each column to obtain the time domain equalizer settings.
   I-Q Whitened Matched Filter (I-Q WMF) Representation

It can be recalled that the MMSE in direct form is given by,

$$w ( f ) = \underbrace{{h}_{1}^{*} ( f ) }_{I - QMF} \underbrace{{[ {h}_{1} ( f ) {h}_{1}^{*} ( f ) + {R}_{ii} ( f ) ]}^{- 1}}_{I - Q MMSE For Colored Noise}$$

Then by applying a matrix inversion formula given by:
(A+BCD)⁻¹=A⁻¹−A⁻¹B(DA⁻¹B+C⁻¹)DA⁻¹,
it is possible to represent the MMSE receiver 10 in alternative form as,

$$w ( f ) = \frac{1}{{[ 1 + {h}_{1}^{*} ( f ) {R}_{ii}^{- 1} ( f ) {h}_{1} ( f ) ]}_{Scalar I - Q MMSE Equalizer for White Noise}} \underbrace{{h}_{i}^{*} ( f ) {R}_{ii}^{- 1} ( f )}_{I - Q WhitenedMF}$$

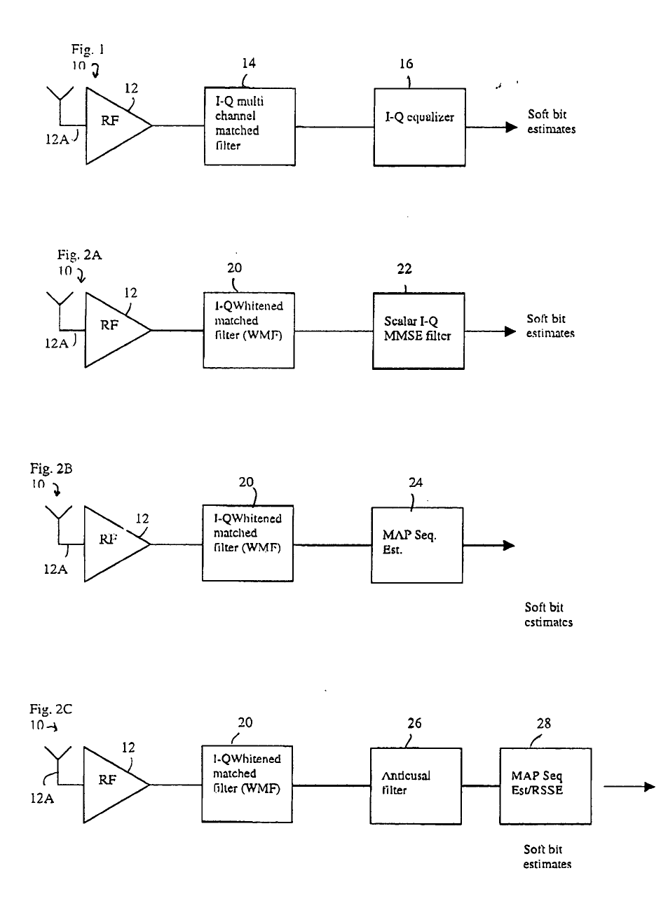

Referring to FIG. 2A, the immediately preceding expression can be interpreted as an I-Q whitened matched filter h₁*(f)Rᵢᵢ⁻¹(f), referred to in FIG. 2A as the I-Q WMF 20, followed by a scalar I-Q MMSE equalizer 22 designed for white noise. The scalar I-Q MMSE equalizer 22 is attractive for practical implementation, as in the case of white noise case it does not involve the use of matrix inversions. Following the I-Q WMF 20, FIG. 2B, an optional Ungerboeck MAP sequence estimator 24 can be used instead of the scalar MMSE filter 22 as an optimum receiver for suppressing ISI (see., for example, W. Koch and A. Bair, “Optimum and Sub-Optimum Detection of Coded Data Disturbed by Time-Varying InterSymbol Interference,” in Proc. GLOBCOM'90, pp. 1679-1684, December 1990). The channel impulse response at the output of the I-Q WMF 20 is given by

$${h}_{IQWMF} ( f ) = {h}_{1}^{*} ( f ) {R}_{ii}^{- 1} ( f ) {h}_{1} ( f )$$

The FFT based algorithm is outlined below:
(A) take a N_{f} point FFT of each row channel impulse response to construct h₁(fₙ) of size 2l×1;
(B) construct Rᵢᵢ(fₙ) by taking FFT of each time domain interference autocorrelation stream;
(C) construct a 1×2l whitened MF row vector

$$\underbrace{{h}_{1}^{*} ( {f}_{n} ) {R}_{ii}^{- 1} ( {f}_{n} )}_{I–Q WhitenedMF} ,$$

and take the IFFT on each column to obtain the time domain I-Q WMF settings; and
(D) obtain the time domain I-Q WMF impulse response by taking the IFFT of h_{IQWMF}(fₙ)=h₁*(fₙ)Rᵢᵢ⁻¹(fₙ)h₁(fₙ).

It should be noted that the WMF and MMSE can be implemented jointly by scaling the I-Q WMF response with

$$\frac{1}{[ 1 + {h}_{IQWMF} ( {f}_{n} ) ]}$$

before taking the IFFT.
I-Q Pre-Whitening Interpretation

One may first define the following matrix square root factorization on Rᵢᵢ(f):
Rᵢᵢ(f)=Lᵢᵢ(f)Lᵢᵢ*(f).

The MMSE weights can be re-arranged as:

$$w ( f ) = \frac{\underbrace{{\tilde{h}}_{1}^{*} ( f )}_{I–Q MF}}{\underbrace{[ 1 + {\tilde{h}}_{1}^{*} ( f ) {\tilde{h}}_{1} ( f ) ]}_{Scalar I–Q MMSE Equalizer for White Noise}} \underbrace{{L}_{ii}^{- 1} ( f )}_{I–Q Pre–whitener} , \\ {\tilde{h}}_{1} ( f ) = {L}_{ii}^{- 1} ( f ) {h}_{1} ( f )$$

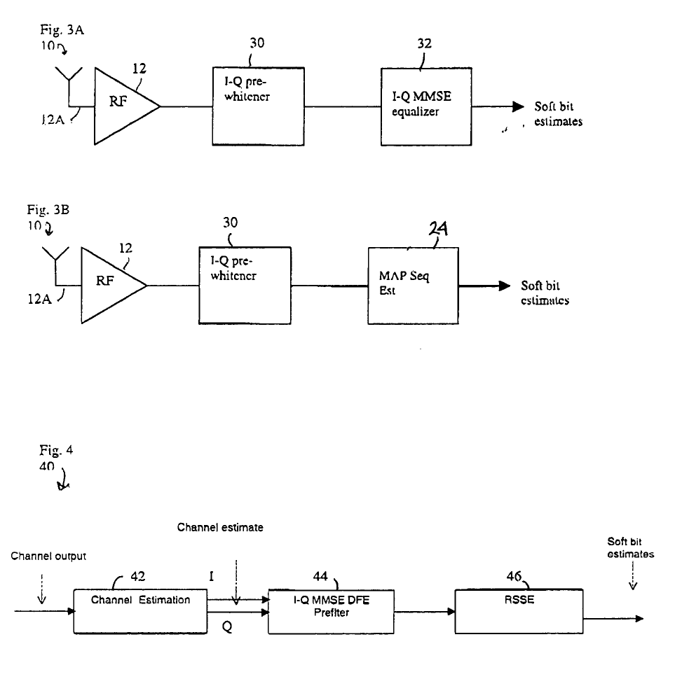

Based on the foregoing, and referring to FIG. 3A, one may then interpret the MMSE receiver 10 as including an I-Q pre-whitener Lᵢᵢ⁻¹(f), I-Q PW 30, that whitens the co-interference across I-Q time dimensions, followed by an I-Q MMSE equalizer 32 optimized for white noise. As was mentioned above with respect to FIG. 2B, as an alternative to the MMSE equalizer 32, FIG. 3B, the MAP sequence estimator 24 (based on Euclidian branch metrics) can be used as an optimum equalizer for ISI suppression. A FFT based pre-whitener can be implemented by the following algorithm:
(A) take the N_{f} point FFT of each row channel impulse response to construct h₁(fₙ) of size 21×1;
(B) construct Rᵢᵢ(fₙ) by taking the FFT of each time domain interference autocorrelation stream;
(C) compute

$$\underbrace{{L}_{ii}^{- 1} ( {f}_{n} )}_{IQ Pre–whitener}$$

as the Choleski factor of a 2l×2l matrix Rᵢᵢ(fₙ) for each frequency bin;
(D) take the IFFT of

$$\underbrace{{L}_{ii}^{- 1} ( {f}_{n} )}_{IQ Pre–whitener}$$

to obtain time domain pre-whitener settings; and
(E) obtain the time domain I-Q pre-whitened impulse response by taking the IFFT of Lᵢᵢ⁻¹(fₙ)h₁(fₙ)

The WMF and MMSE can be implemented jointly by scaling the pre-whitener 30 with

$$\frac{{\tilde{h}}_{1}^{*} ( {f}_{n} )}{[ 1 + {\tilde{h}}_{1}^{*} ( {f}_{n} ) {\tilde{h}}_{1} ( {f}_{n} ) ]}$$

before taking IFFT.

FIG. 2C is a simplified block diagram of a further embodiment of a I-Q MMSE receiver 10 that includes the I-Q whitened matched filter 20 and an anticusal filter 26 that produces a minimum phase channel. The anticusal filter 26 may be used with a MAP sequence estimator with a Euclidean filter metric (Forney)/Reduced State Sequence Estimator (RSSE) 28, or with a Decision Feedback Estimator (DFE).

I-Q MMSE-DFE

Extending the results of Sirikiat Lek Ariyavisitakul, J. H. Winters, “Optimum Space-Time Processors with Dispersive Interference: Unified Analysis and Required Filter Span”, IEEE Trans on Comm, July 1999; J. Cioffi et al, “MMSE Decision Feedback Equalizers and Coding Part-I”, IEEE Trans on Comm., October 1995; and J. Cioffi, “Class Notes EE 379A Stanford University”, the frequency domain form of the I-Q MMSE-DFE maybe represented as:

$$w ( f ) = \frac{[ 1 + b ( f ) ] {h}_{1}^{*} ( f ) {R}_{ii}^{- 1} ( f )}{[ 1 + {h}_{1}^{*} ( f ) {R}_{ii}^{- 1} ( f ) {h}_{1} ( f ) ]} ,$$

where [1+b(f)] is the feedback filter. w(f) can be represented in an alternative form as

$$w ( f ) = \frac{[ 1 + b ( f ) ] {\tilde{h}}_{1}^{*} ( f ) {L}_{ii}^{- 1} ( f )}{[ 1 + {\tilde{h}}_{1}^{*} ( f ) {\tilde{h}}_{1} ( f ) ]} , where$$

$${R}_{ii} ( f ) = {L}_{ii} ( f ) {L}_{ii}^{*} ( f ) and {\tilde{h}}_{1} ( f ) = {L}_{ii}^{- 1} ( f ) {h}_{1} ( f ) .$$

The above form suggests that the I-Q MMSE-DFE, with colored noise, can be represented in three stages, first as an I-Q pre-whitener, second as a MMSE equalizer, and third as a prediction error filter [1+b(f)]. Note that the b(f)=0 condition corresponds to the I-Q MMSE receiver shown in FIGS. 3A and 3B. The feedback filter [1+b(f)] is chosen as a canonical factor of [1+h₁*(f)Rᵢᵢ⁻¹(f)h₁(f)], i.e.,
[1+h₁* (f)Rᵢᵢ⁻¹(f)h₁(f)]=S₀g(f)g*(f),
where
[1+b(f)]=g(f).

The minimum MSE for DFE is given by

$${MSE}_{min} = \frac{1}{{S}_{0}} = {ⅇ}^{- ∮ ln \{ 1 + {{h}_{1} ( f )}^{*} {R}_{ii}^{- 1} ( f ) {h}_{1} ( f ) \} ⅆ f} .$$

The feedback filter settings may be obtained through Cepstrum-based methods (see, for example, Oppenheim, Schafer, “Digital Signal Processing”, Prentice-Hall). In the publication by Inkyu Lee and J. Cioffi, “A Fast Computation Algorithm for Decision Feedback Equalizer”, IEEE Trans on Comm, November 1995, a FIR approximation to MMSE-DFE settings was obtained by using FFTs. In severe ISI channels, the DFE is preferably replaced with a RSSE, (reduced state sequence estimator). For example, reference can be made to M. Eyuboglu and S. Quereshi, “Reduced State Sequence Estimation with Set Partitioning and Decision Feedback”, IEEE Trans. Comm, vol.36, pp. 12-20, January 1988.

With regard to the foregoing, the following points are noted.

In the white noise case, the I-Q MMSE-DFE pre-filter does not offer any additional benefit if a full trellis detector is used after the pre-filtering operation. This follows as a consequence of the fact that a conventional MMSE-DFE feed-forward filter is itself a canonical structure for further MAP sequence estimation (see, for example, J. Cioffi et al, “MMSE Decision Feedback Equalizers and Coding Part-I”, IEEE Trans on Comm., October 1995). On the other hand, the I-Q MMSE-DFE feed-forward filter may offer some gain, if an RSSE structure is used after I-Q pre-filter. The gain depends on the severity of the ISI channel.

In the case of CCI, the I-Q MMSE-DFE pre-filter functions as an I-Q whitened matched filter that suppresses the CCI, irrespective of the number of states used in a subsequent sequence estimation step.

FIR Implementation

FIR I-Q MMSE

The frequency domain formulation assumes infinite length filters. However, for DSP and ASIC applications, the MMSE design is typically carried out in the time domain using FIR filters, mainly due to numerical considerations. The FIR optimization, despite its exactness, requires computationally intensive matrix operations, for example, those required for inverting the block Toeplitz correlation matrix through Levinson recursion.

What is described now is a technique to formulate the FIR solution in the exact form. One first stacks up N_{f} samples in a column vector as:

$$[ \begin{matrix}{y}_{k} \\ {y}_{k - 1} \\ ⋮ \\ {y}_{k - {N}_{f} + 1}\end{matrix} ] = {\sum }_{j = 1}^{M} [ \begin{matrix}{h}_{0}^{( j )} & {h}_{1}^{( j )} & … & {h}_{v}^{( j )} & 0 & … & 0 \\ 0 & {h}_{0}^{( j )} & {h}_{1}^{( j )} & … & {h}_{v}^{( j )} & 0 & … \\ ⋮ & & & & & & ⋮ \\ 0 & … & 0 & {h}_{0}^{( j )} & {h}_{1}^{( j )} & … & {h}_{v}^{( j )}\end{matrix} ] [ \begin{matrix}\begin{matrix}\begin{matrix}{x}_{k}^{( j )} \\ {x}_{k - 1}^{( j )}\end{matrix} \\ ⋮\end{matrix} \\ {x}_{k - {N}_{f} - v + 1}^{( j )}\end{matrix} ] + [ \begin{matrix}\begin{matrix}\begin{matrix}{n}_{k} \\ {n}_{k -}\end{matrix} \\ ⋮\end{matrix} \\ {n}_{k - {N}_{f} - v + 1}\end{matrix} ] .$$

Then the real and imaginary parts of the samples are stacked up as,

$${y}_{k} = [ \begin{matrix}Re \{ y ( kT , 1 ) \} \\ Im \{ y ( kT , 1 ) \} \\ ⋮ \\ Re \{ y ( kT , l ) \} \\ Im \{ y ( kT , l ) \}\end{matrix} ] {h}_{n}^{( j )} = [ \begin{matrix}Re \{ {h}^{( j )} ( kT , 1 ) \} \\ Im \{ {h}^{( j )} ( kT , 1 ) \} \\ ⋮ \\ Re \{ {h}^{( j )} ( kT , l ) \} \\ Im \{ {h}^{( j )} ( kT , l ) \}\end{matrix} ] {y}_{k} = [ \begin{matrix}Re \{ n ( kT , 1 ) \} \\ Im \{ n ( kT , 1 ) \} \\ ⋮ \\ Re \{ n ( kT , l ) \} \\ Im \{ n ( kT , l ) \}\end{matrix} ] .$$

Using compact matrix notation,
Yₖ=H₁Xₖ⁽¹)+Iₖ,
where

$${I}_{k} = {\sum }_{j = 2}^{M} {H}_{j} {X}_{k}^{( j )} + {N}_{k}$$

is the total interference plus noise term, Hⱼ is a block Toeplitz channel matrix of size 2lN_{f}×2l(N_{f}+v)), and Xₖ^{(j) and N}ₖ are data and noise vectors. Then define a 1×2lN_{f} row vector w that minimizes the mean square error between zₖ=wYₖ and x_{k-Δ} as:
w=1_{Δ}*H₁*└H₁H₁*+Rᵢᵢ⁻¹┘,
where 1_{Δ} is a (N_{f}+v) vector of 0's with a 1 in the _{Δ+1} st position, and where _{Δ} is an appropriately chosen equalizer delay, which may be chosen as

$$\frac{( {N}_{f} + v )}{2}$$

for feed-forward filters of sufficient length N_{f}. The equalizer delay can also be variable. The interference plus noise auto correlation function is defined as Rᵢᵢ=E[IₖIₖ*]. The feed-forward filter can also be represented in an alternative form by using the matrix inversion formula as:
w=1_{Δ}*H₁*[H₁*Rᵢᵢ⁻¹H₁+I]⁻¹H₁*Rᵢᵢ⁻¹.

The connection between the FIR and frequency domain structures can be made if one approximates the block Toeplitz matrices as circulate matrices, and then diagonalizes the circulant matrices using DFT matrices. Reference in this regard can be made to Inkyu Lee and J. Cioffi, “A Fast Computation Algorithm for Decision Feedback Equalizer”, IEEE Trans on Comm, November 1995.

Interference Plus Noise Correlation Matrix Estimation

In a burst mode transmission, such s a GSM transmission, both the channel response and the interference correlation matrix are estimated directly from the training portion of the burst. Typically, a least squares method is used for channel estimation. In this case, the correlation matrix estimation is estimated as:

$${\hat{I}}_{k} = {\overbrace{{Y}_{k} - {\hat{H}}_{1} {X}_{k}^{( 1 )}}}^{Over Training Portion}$$

$${R}_{ii} = {\overbrace{E [ {\hat{I}}_{k} {\hat{I}}_{k}^{*} ]}}^{Over Training Portion}$$

The expectation operation can be carried out as a time average over the training span. In general, the correlation matrix estimate is quite noisy due to the short training span (e.g., 26-symbols long), resulting in poor BER performance.

However, by pre-multiplying with an empirical window function, the correlation matrix estimate can be improved, as windowing reduces the variance of the auto-correlation estimate. For example we can choose to apply one of the following windowing (e.g., see Oppenheim, Schafer, “Digital Signal Processing”, Prentice-Hall) functions. Some example window functions are given by:

$$s ( n ) = \{ \begin{matrix}0.42 - 0.5 cos ( \frac{2 π ( n )}{N - 1} ) + 0.08 cos ( \frac{4 π ( n )}{N - 1} ) & Blackman \\ 0.5 - 0.5 cos ( \frac{2 π ( n )}{N - 1} ) & Hanning \\ 0.54 - 0.46 cos ( \frac{2 π ( n )}{N - 1} ) & Hamming\end{matrix}$$

As an alternative, one can compute the interference correlation matrix based on a longer data observation window as,
\hat{R}ᵢᵢ=\hat{R}_{YY}−Ĥ₁Ĥ₁*
Since \hat{R}_{YY} can be calculated over a long observation window (whole burst of data can be used), we can expect an improved correlation matrix estimate.
FIR I-Q MMSE-DFE

Following the notation in J. Cioffi “Class Notes EE 379A Stanford University”, the MMSE-DFE feed-forward and feedback filters in FIR form are given by:
w=1_{Δ}*H₁*[H₁H₁*−H₁J_{Δ}J_{Δ}*H₁*+Rᵢᵢ]⁻¹
b=1_{Δ}*H₁*[H₁H₁*−H₁J_{Δ}J_{Δ}*H₁*+Rᵢᵢ]⁻¹H₁J_{Δ}
where J_{Δ}=E[Yₖx*_{k-Δ-1}*].

It is noted that the MMSE-DFE solution has other forms and fast algorithms associated with these solutions. For example, the methods described in the following publications can be employed when the MMSE-DFE optimization is performed on real and imaginary streams: Al-Dhahir, “A Computationally Efficient FIR MMSE-DFE for CCI Impaired Dispersive Channels”, IEEE Trans on Signal Processing, January 1997; N. Al-Dhahir and J. Cioffi, “MMSE Decision-Feedback Equalizers: Finite Length Results”, IEEE Trans on Information Theory, July 1995; and Inkyu Lee and J. Cioffi, “A Fast Computation Algorithm for Decision Feedback Equalizer”, IEEE Trans on Comm, November 1995.

A further GSM RF receiver embodiment is shown in FIG. 4 as a receiver 40 that includes a channel estimation block 42 that outputs a channel estimate, followed by a full whitening I-Q MMSE-DFE pre-filter 44, followed in turn by a RSSE 46. This receiver embodiment is particularly useful for colored noise, and does not require a full trellis equalizer. The full whitening I-Q MMSE-DFE pre-filter 44 may be based on FIR or on frequency domain techniques. The I-Q MMSE-DFE pre-filter 44 not only whitens interference across I-Q-time space, but also provides a minimum phase channel output suitable for the further reduced state sequence estimation performed by RSSE 46. State reduction to as little as 1-state (i.e., a DFE) is achievable without significant loss of performance.

A system designer may select a particular I-Q MMSE whitening embodiment from those given above based on the computational and performance requirements of a given application.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims.

As but a few examples, the use of this invention is not restricted to burst-type systems, such as GSM or GSM/EDGE systems, but can be applied as well in code division, multiple access (CDMA) systems, including wide bandwidth CDMA (WCDMA) systems. The teachings of this invention are also not restricted for use only in SAIC receivers, as other types of receiver systems may also benefit from the use of this invention. In addition, it should be realized that the invention can be practiced substantially only in hardware, such as by designing an ASIC to perform the functions described above, or substantially only in software, such as with a suitably-programmed DSP, or with a combination of hardware and software. However, all such and similar modifications of the teachings of this invention will still fall within the scope of this invention. Further, while the method and apparatus described herein are provided with a certain degree of specificity, the present invention could be implemented with either greater or lesser specificity, depending on the needs of the user. Further, some of the features of the present invention could be used to advantage without the corresponding use of other features. As such, the foregoing description should be considered as merely illustrative of the principles of the present invention, and not in limitation thereof, as this invention is defined by the claims which follow.

1. A radio frequency (RF) receiver, comprising baseband means for performing Minimum Mean-Square Error (MMSE) optimization for substantially simultaneously suppressing inter-symbol interference (ISI) and co-channel interference (CCI) on a signal stream comprising real and imaginary signal components.

2. A RF receiver as in claim 1, where said receiver comprises a single receive antenna, and operates as a single/multi antenna interference cancellation (SAIC) receiver.

3. A RF receiver as in claim 1, where said baseband means comprises means for determining a set of In-Phase and Quadrature Phase (I-Q) MMSE vector weights that are used to perform the ISI suppression and the CCI suppression.

4. A RF receiver as in claim 3, where signal interference correlation matrices are utilized when calculating I-Q MMSE coefficients, and where the vector weights are synthesized using FIR calculations.

5. A RF receiver as in claim 3, where signal interference correlation matrices are utilized when calculating I-Q MMSE coefficients, and where the vector weights are synthesized using frequency domain calculations.

6. A RF receiver as in claim 5, where the frequency domain calculations comprise Fast Fourier Transform (FFT) calculations.

7. A RF receiver as in claim 1, where said baseband means comprises a multiplier for multiplying the set of determined I-Q MMSE weight vectors with a received signal vector, and said RF receiver further comprises decision means, coupled to an output of said baseband means, for making bit soft decisions on the signal output from said baseband means.

8. A RF receiver as in claim 7, where said decision means comprises a reduced state sequence estimator (RSSE).

9. A RF receiver as in claim 7, where said decision means comprises a trellis detector that uses Euclidian metrics.

10. A RF receiver as in claim 7, where said decision means comprises a trellis detector that uses Ungerboeck metrics.

11. A RF receiver as in claim 1, where said baseband means comprises a multiplier for multiplying the set of determined I-Q MMSE weight vectors with a received signal vector, and outputs bit soft decisions based on the result of the multiplication.

12. A RF receiver as in claim 1, where said baseband outputs samples y(k) of the received signal represented as,
$${y}_{k , q} = {\sum }_{p = 0}^{v} {x}_{k - p}^{( 1 )} {h}_{p , q}^{( 1 )} + {\sum }_{j = 2}^{M} {\sum }_{p = 0}^{v} {x}_{k - p}^{( j )} {h}_{l , q}^{( j )} + {n}_{k , q} , q = 1 , 2 … l .$$

13. A RF receiver as in claim 12, where the real and imaginary parts of the time domain received signal are stacked in a column vector, and the received signal in the frequency-domain is represented as,
$$y ( f ) = {h}_{1} ( f ) {x}_{1} ( f ) + {\sum }_{j = 2}^{M} {h}_{j} ( f ) {x}_{j} ( f ) + n ( f ) ,$$

14. A RF receiver as in claim 13, where an MMSE filter w(f) that minimizes the mean square error term defined as,
MSE=o∫E└∥w(f)y(f)−x₁(f)∥²┘df.

15. A RF receiver as in claim 14, where the MMSE weights in direct form are given by,
$$w ( f ) = {\underbrace{{h}_{1}^{*} ( f )}}_{1 - QMF} {\underbrace{{[ {R}_{SS} ( f ) + {R}_{ii} ( f ) ]}^{- 1}}}_{1 - Q MMSE For Colored Noise} .$$

16. A RF receiver as in claim 12, where for an I-Q whitened matched filter embodiment the MMSE receiver is represented as,
$$w ( f ) = \frac{1}{{\underbrace{[ 1 + {h}_{1}^{*} ( f ) {R}_{ii}^{- 1} ( f ) {h}_{1} ( f ) ]}}_{Scalar 1 - Q MMSE Equalizer for White Noise}} {\underbrace{{h}_{1}^{*} ( f ) {R}_{ii}^{- 1} ( f )}}_{I - Q WhitenedMF} .$$

17. A RF receiver as in claim 3, where for an I-Q pre-whitening embodiment the MMSE weights are arranged as,
$$w ( f ) = \frac{{\underbrace{{\tilde{h}}_{1}^{*} ( f )}}_{I - Q MF}}{{\underbrace{[ 1 + {\tilde{h}}_{1}^{*} ( f ) {\tilde{h}}_{1} ( f ) ]}}_{Scalar - I - Q MMSE Equalizer for White Noise}} {\underbrace{{L}_{ii}^{- 1} ( f )}}_{I - Q Pre - whitener} , \\ {\tilde{h}}_{1} ( f ) = {L}_{ii}^{- 1} ( f ) {h}_{1} ( f ) .$$

18. A RF receiver as in claim 3, where said baseband means operates as a frequency domain I-Q pre-whitener that uses a matrix that is synthesized based on an I-Q interference correlation matrix.

19. A RF receiver as in claim 3, where said baseband means operates as a frequency domain I-Q whitened matched filter that uses a matrix that is synthesized based on an I-Q interference correlation matrix.

20. A RF receiver as in claim 3, where said baseband means operates as a frequency domain I-Q pre-whitener that uses a matrix that is synthesized based on an I-Q interference correlation matrix and that outputs pre-whitened signal stream, said RF receiver further comprising a sequence estimator that processes said pre-whitened signal stream with combined I-Q branches within a branch metric, using one of Euclidian and Ungerboeck metrics.

21. A RF receiver as in claim 3, where said baseband means operates as a frequency domain I-Q whitener matched filter that uses a matrix that is synthesized based on an I-Q interference correlation matrix and that outputs a whitened signal stream, said RF receiver further comprising a sequence estimator that processes said whitened signal stream with combined I-Q branches within a branch metric, using one of Euclidian and Ungerboeck metrics.

22. A RF receiver as in claim 3, where said baseband means operates as an I-Q MMSE Decision Feedback Equalizer (DFE) pre-filter that outputs a pre-filtered signal stream, said RF receiver further comprising a reduced state sequence estimator (RSSE) that processes said pre-filtered signal stream.

23. A RF receiver as in claim 1, where a frequency domain form of the I-Q MMSE-DFE is represented as one of,
$$w ( f ) = \frac{[ 1 + b ( f ) ] {h}_{1}^{*} ( f ) {R}_{ii}^{- 1} ( f )}{[ 1 + {h}_{1}^{*} ( f ) {R}_{ii}^{- 1} ( f ) {h}_{1} ( f ) ]} , and$$
$$w ( f ) = \frac{[ 1 + b ( f ) ] {\tilde{h}}_{1}^{*} ( f ) {L}_{ii}^{- 1} ( f )}{[ 1 + {\tilde{h}}_{1}^{*} ( f ) {\tilde{h}}_{1} ( f ) ]} ,$$
where [1+b(f)] is a feedback filter.

24. A RF receiver as in claim 1, where for a FIR solution in an exact form, N_{f} samples are stacked in a column vector as:
$$\begin{matrix}[ \begin{matrix}{y}_{k} \\ {y}_{k - 1} \\ ⋮ \\ {y}_{k - {N}_{f} + 1}\end{matrix} ] = {\sum }_{j = 1}^{M} [ \begin{matrix}{h}_{0}^{( j )} & {h}_{1}^{( j )} & … & {h}_{v}^{( j )} & 0 & … & 0 \\ 0 & {h}_{0}^{( j )} & {h}_{1}^{( j )} & … & {h}_{v}^{( j )} & 0 & … \\ ⋮ & & & & & & ⋮ \\ 0 & … & 0 & {h}_{0}^{( j )} & {h}_{1}^{( j )} & … & {h}_{v}^{( j )}\end{matrix} ] \\ [ \begin{matrix}{x}_{k}^{( j )} \\ {x}_{k - 1}^{( j )} \\ ⋮ \\ {x}_{k - {N}_{f} - v + 1}^{( j )}\end{matrix} ] + [ \begin{matrix}\begin{matrix}\begin{matrix}{n}_{k} \\ {n}_{k - 1}\end{matrix} \\ ⋮\end{matrix} \\ {n}_{k - {N}_{f} - v + 1}\end{matrix} ] .\end{matrix}$$
and real and imaginary parts of the samples are stacked as,
$${y}_{k} = [ \begin{matrix}Re \{ y ( kT , 1 ) \} \\ Im \{ y ( kT , 1 ) \} \\ ⋮ \\ Re \{ y ( kT , l ) \} \\ Im \{ y ( kT , l ) \}\end{matrix} ] {h}_{n}^{( j )} = [ \begin{matrix}Re \{ {h}^{( j )} ( kT , 1 ) \} \\ Im \{ {h}^{( j )} ( kT , 1 ) \} \\ ⋮ \\ Re \{ {h}^{( j )} ( kT , l ) \} \\ Im \{ {h}^{( j )} ( kT , l ) \}\end{matrix} ] {n}_{k} = [ \begin{matrix}Re \{ n ( kT , 1 ) \} \\ Im \{ n ( kT , 1 ) \} \\ ⋮ \\ Re \{ n ( kT , l ) \} \\ Im \{ n ( kT , l ) \}\end{matrix} ] .$$

25. A RF receiver as in claim 24, where a 1×2lN_{f} row vector w that minimizes the mean square error between zₖ=wYₖ and x_{k-Δ} is given by,
w=1_{Δ}*H₁*└H₁H₁*+Rᵢᵢ⁻¹┘,
where 1_{Δ} is a (N_{f}+v) vector of 0's with a 1 in the _{Δ+1} st position, and where _{Δ} is an equalizer delay that is one of variable or that is selected as
$$\begin{matrix}n ( f ) = {[ {n}_{I , 1} ( f ) … {n}_{I , q} ( f ) … {n}_{I , l} ( f ) {n}_{Q , 1} ( f ) … {n}_{Q , q} ( f ) … {n}_{Q , l} ( f ) ]}^{T} \\ {n}_{I , q} ( f ) = {\sum }_{k}^{} Re \{ {n}_{k , q} \} {ⅇ}^{j 2 π k fT} \\ {n}_{Q , q} ( f ) = {\sum }_{k}^{} Im \{ {n}_{k , q} \} {ⅇ}^{j 2 π k fT}\end{matrix}$$
for feed-forward filters of length N_{f}.

26. A RF receiver as in claim 24, where a feed-forward filter is represented using a matrix inversion formula as,
w=1_{Δ}*H₁*[H₁*Rᵢᵢ⁻¹H₁+I]⁻¹H₁*Rᵢᵢ⁻¹.

27. A RF receiver as in claim 1, where MMSE-DFE feed-forward and feedback filters in FIR form are given by,
w=1_{Δ}*H₁*[H₁H₁*−H₁J_{Δ}J_{Δ}*H₁*+Rᵢᵢ]⁻¹,
and
b=1_{Δ}*H₁*[H₁H₁*−H₁J_{Δ}J_{Δ}*H₁*+Rᵢᵢ]⁻¹H₁J_{Δ},
where J_{Δ}=E[Yₖx*_{k-Δ-1}*].

28. A method to operate a radio frequency (RF) receiver, comprising:
receiving a signal comprising real and imaginary signal components; and
performing Minimum Mean-Square Error (MMSE) optimization on said received signal for substantially simultaneously suppressing inter-symbol interference (ISI) and co-channel interference (CCI).

29. A method as in claim 28, where said signal is received through a single receive antenna, and said RF receiver operates as a single/multi antenna interference cancellation (SAIC) receiver.

30. A method as in claim 28, where performing MMSE optimization comprises determining a set of In-Phase and Quadrature Phase (I-Q) MMSE vector weights that are used to perform the ISI suppression and the CCI suppression.

31. A method as in claim 30, further comprising using signal interference correlation matrices when calculating I-Q MMSE coefficients, and synthesizing the vector weights using FIR calculations.

32. A method as in claim 30, further comprising using signal interference correlation matrices when calculating I-Q MMSE coefficients, and synthesizing the vector weights using frequency domain calculations.

33. A method as in claim 32, where the frequency domain calculations comprise Fast Fourier Transform (FFT) calculations.

34. A method as in claim 28, where performing MMSE optimization comprises multiplying the set of determined I-Q MMSE weight vectors with a received signal vector to generate a result signal, and further comprising making bit soft decisions on the result signal.

35. A method as in claim 34, where making bit soft decisions uses a reduced state sequence estimator (RSSE).

36. A method as in claim 34, where making bit soft decisions uses a trellis detector that uses Euclidian metrics.

37. A method as in claim 34, where making bit soft decisions uses a trellis detector that uses Ungerboeck metrics.

38. A method as in claim 28, where performing MMSE optimization comprises multiplying the set of determined I-Q MMSE weight vectors with a received signal vector, and outputting bit soft decisions based on the result of the multiplication.

39. A method as in claim 30, where performing MMSE optimization comprises operating a frequency domain I-Q pre-whitener that uses a matrix that is synthesized based on an I-Q interference correlation matrix.

40. A method as in claim 30, where performing MMSE optimization comprises operating a frequency domain I-Q whitened matched filter that uses a matrix that is synthesized based on an I-Q interference correlation matrix.

41. A method as in claim 30, where performing MMSE optimization comprises operating a frequency domain I-Q pre-whitener that uses a matrix that is synthesized based on an I-Q interference correlation matrix and that outputs pre-whitened signal stream, further comprising processing said pre-whitened signal stream with a sequence detector that combines I-Q branches within a branch metric, and that uses one of Euclidian and Ungerboeck metrics.

42. A method as in claim 30, where performing MMSE optimization comprises operating a frequency domain I-Q whitener matched filter that uses a matrix that is synthesized based on an I-Q interference correlation matrix and that outputs a whitened signal stream, further comprising processing said whitened signal stream with a sequence detector that combines I-Q branches within a branch metric, and that uses one of Euclidian and Ungerboeck metrics.

43. A method as in claim 30, where performing MMSE optimization comprises operating an I-Q MMSE Decision Feedback Equalizer (DFE) pre-filter that outputs a pre-filtered signal stream, further comprising operating a reduced state sequence estimator (RSSE) that processes said pre-filtered signal stream
